(19) United States
(12) Patent Application Publication
(10) Pub. No.: US 2017/0001534 A1
(43) Pub. Date: Jan. 5, 2017

(54) DEVICE AND METHOD FOR CONTROLLING BATTERY CHARGE AND DISCHARGE QUANTITY IN ECO-FRIENDLY VEHICLE

(71) Applicant: Hyundai Motor Company, Seoul (KR)

(72) Inventors: Teh Hwan Cho, Anseong (KR); Gwang Il Du, Incheon (KR); Jee Wook Huh, Bucheon (KR)

(21) Appl. No.: 14/960,663

(22) Filed: Dec. 7, 2015

(30) Foreign Application Priority Data
Jun. 30, 2015 (KR) 10-2015-0093359

(51) Int. Cl. B60L 11/18

(52) U.S. Cl. CPC B60L 11/1861; B60L 11/1848

(57) ABSTRACT

A device and method are provided for controlling battery charge and discharge quantity in an eco-friendly vehicle equipped with a high voltage battery to optimize the battery charge and discharge quantity. More specifically, the device and method prevent limitations of battery low-voltage/overvoltage due to excessive use of electrical energy stored in a battery using battery state of charge (SOC), battery temperature information, and battery voltage information. Additionally, the fuel efficiency and the power performance are improved by securing an additional motor output using existing hardware without addition of parts compared to a related art.

### CROSS-REFERENCE TO RELATED APPLICATION

This application claims under 35 U.S.C. §119(a) the benefit of Korean Patent Application No. 10-2015-0093359 filed Jun. 30, 2015, the entire contents of which are incorporated herein by reference.

### BACKGROUND

(a) Technical Field

The present disclosure relates to a device and method for controlling the battery charge and discharge quantity in an eco-friendly vehicle, and more particularly, the to a device and method for optimally controlling the battery charge and discharge quantity in an eco-friendly vehicle equipped with a high-voltage battery.

(b) Background Art

Generally, eco-friendly vehicles such as hybrid electric vehicles, plug-in hybrid vehicles, and electric vehicles that use an electric motor as a driving source are equipped with a high-voltage battery for power supply to the electric motor. Conventional eco-friendly vehicles implement driving of optimal fuel efficiency by charging a high-voltage battery using a drive motor or a generator during driving, or by using electrical energy stored in a high-voltage battery.

However, conventional eco-friendly vehicles inevitably use the limited capacity of the drive motor due to structural limitations (e.g., limited mounting space of engine room) causing an increase of weight and manufacturing cost of vehicles, and have difficulty in achieving high fuel efficiency and power performance by maximally utilizing an electric power source due to these systemic limitations.

As shown in FIG. 4, the hybrid control unit (HCU) is configured to determine the battery output limit for limiting the maximum values of battery charge power and battery discharge power using the battery state of charge (SOC) and the battery temperature information input from a battery management system (BMS). Additionally, the HCU is configured to compare the determined battery output limit (e.g., value limiting the battery maximum output for battery charge/discharge) with the battery output limit input from the BMS, and subtract a particular margin from a smaller one of the two battery output limits to determine a motor output limit (e.g., value limiting the motor maximum output during battery charge/discharge).

Thus, the determined motor output limit has the battery output limit and a particular margin, and the margin between the battery output limit and the motor output limit is fixed into a particular value regardless of the battery SOC. In particular, when the battery SOC is low, a battery cell voltage is output while having a great difference from the battery output limit, causing the reduction of the fuel efficiency and the power performance. More specifically, the HCU is configured to determine the battery SOC state based on the battery SOC level based on the battery SOC input from the BMS using a first table that is pre-generated, and determine a weighting factor for limiting the battery charge/discharge power for each determined battery SOC state using a second table that is pre-generated.

Furthermore, the HCU is configured to determine the battery charge/discharge power based on the battery temperature and the battery SOC based on the battery temperature and the battery SOC information input from the BMS using a third table that is pre-generate. The HCU is configured to calculate the battery output limit as a limited value by multiplying the determined battery charge/discharge power by the weighting factor, and then compare the calculated battery output limit with the battery output limit input from the BMS to determine the motor output limit from a value obtained by subtracting a certain margin from a smaller value of the two battery output limits.

However, in an HCU, only the battery temperature and the battery SOC are considered as factors limiting the motor output to calculate the motor output limit (or motor charge/discharge power limit) without considering the battery cell voltage that is a main factor substantially affecting the motor output. Thus, there is a great margin between the battery output limit (value limiting battery maximum output) set in consideration of the overvoltage and low-voltage condition of a battery and an actually monitored battery cell voltage.

For example, referring to FIG. 5, when the battery SOC is high, the control margin between the monitored battery cell voltage and the set battery output limit (voltage limit value) is minimal. However, when the battery SOC is low, the control margin between the monitored battery cell voltage and the set battery output limit (voltage limit value) is significantly high. In particular, since the motor maximum output for the battery charge is limited to a particular value by the motor output limit regardless of the level of the battery SOC, the regenerative braking amount is limited even though additional regenerative braking is possible. Accordingly, the motor charge power by the regenerative braking is limited, and the battery cell voltage output is low.

In other words, since the motor charge power is limited to a particular value without regard to the cell voltage based on the battery SOC, the regenerative braking amount is limited. Thus, the battery charge over the motor output limit is impossible, and the optimal control in which the output of high-voltage battery is maximally utilized is also impossible (see FIG. 6).

The above information disclosed in this section is merely for enhancement of understanding of the background of the invention and therefore it may contain information that does not form the prior art that is already known in this country to a person of ordinary skill in the art.

### SUMMARY

The present invention provides a device and method for controlling the battery charge and discharge quantity in an eco-friendly vehicle, which may prevent limitations of battery low-voltage/overvoltage due to excessive use of electrical energy stored in a battery using battery state of charge (SOC), battery temperature information, and battery voltage information, and may improve the fuel efficiency and the power performance by securing an additional motor output using existing hardware without addition of parts compared to a related art.

In one aspect, the present invention provides a device for controlling a battery charge and discharge quantity in an eco-friendly vehicle that may include a motor output controller configured to determine a primary motor output limit based on information regarding battery state of charge (SOC) and battery temperature, determine a weighting factor of the primary motor output limit based on information on the battery SOC and battery voltage, and determine a final motor output limit by correcting the primary motor output limit using the weighting factor.

Particularly, the motor output controller may be configured to receive information of battery SOC, battery temperature and battery voltage from the BMS. In an exemplary embodiment, the motor output controller may be configured to calculate a battery voltage gradient based on the battery voltage information, and may be configured to determine the weighting factor of the primary motor output limit based on the battery SOC and a battery voltage value corrected in consideration of the calculated battery voltage gradient. In addition, the motor output controller may be configured to determine a corrected battery voltage value based on a battery voltage gradient by a battery voltage correction table, and may be configured to determine the weighting factor of the primary motor output limit based on the battery SOC and the corrected battery voltage value by a weighting factor table. The motor output controller may further be configured to receive the information on battery SOC, battery temperature and battery voltage from a battery management system (BMS).

In another aspect, the present invention provides a method for controlling a battery charge and discharge quantity in an eco-friendly vehicle that may include: determining a primary motor output limit based on information on battery state of charge (SOC) and battery temperature; determining a weighting factor of the primary motor output limit based on information regarding battery SOC and battery voltage; and determining a final motor output limit by correcting the primary motor output limit using the weighting factor.

### BRIEF DESCRIPTION OF THE DRAWINGS

The above and other features of the present invention will now be described in detail with reference to=exemplary embodiments thereof illustrated the accompanying drawings which are given hereinbelow by way of illustration only, and thus are not limitative of the present invention, and wherein:

FIG. 1 is a view illustrating a device for controlling the battery charge and discharge quantity in an eco-friendly vehicle according to an exemplary embodiment of the present invention;

FIG. 2 is a view illustrating a method for controlling the battery charge and discharge quantity in an eco-friendly vehicle according to an exemplary embodiment of the present invention;

FIG. 3 is a view illustrating an effect of a method for controlling the battery charge and discharge quantity in an eco-friendly vehicle according to an exemplary embodiment of the present invention;

FIG. 4 is a view illustrating a generally used method for controlling the battery charge and discharge quantity in an eco-friendly vehicle according to a related-art; and

FIGS. 5 and 6 are views illustrating limitations of a generally used method for controlling the battery charge and discharge quantity in an eco-friendly vehicle according to a related-art.

Reference numerals set forth in the Drawings includes reference to the following elements as further discussed below:
1: Battery Management System (BMS)
2: Hybrid Control Unit (HCU)

It should be understood that the accompanying drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Generally, eco-friendly vehicles are equipped with a battery management system (BMS) configured to manage the overall state of the high-voltage battery. The BMS may be configured to monitor the battery state and provide a battery output limit (e.g., value limiting the maximum output of battery) to protect the battery for a hybrid control unit (HCU) that is an upper controller configured to operate various lower controllers within the vehicle. The BMS may be configured to monitor the current battery state, and when any one of battery overheat, battery overvoltage or low-voltage, and battery power overdischarge or overcharge (e.g., when exceeding the maximum output condition for a certain time or more) is met, the BMS may be configured to output a request to HCU to limit the maximum value of motor charge/discharge power to limit the battery maximum output value.

Hereinafter, exemplary embodiments of the present invention will be described in detail with reference to the accompanying drawings so that those skilled in the art can easily carry out the present invention. In this exemplary embodiment, an additional motor output (e.g., motor charge/discharge power) and a battery charge/discharge quantity may be secured, and simultaneously, the fuel efficiency and the power performance may be improved, by variably adjusting in real-time a motor output limit for limitation on motor charge power for battery charge and limitation on motor discharge power for battery discharge using information on battery temperature, battery stage of charge (SOC), and battery voltage.

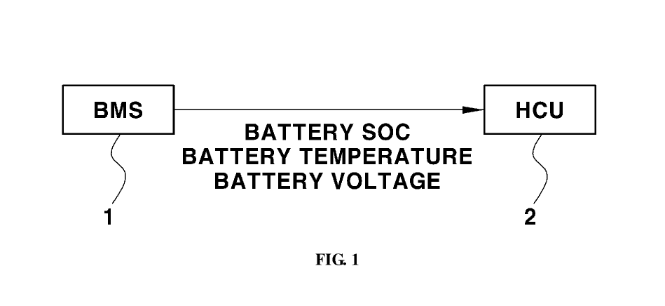

As shown in FIG. 1, a device for controlling the battery charge/discharge quantity in an eco-friendly vehicle according to an exemplary embodiment of the present invention may include a battery management system (BMS) 1 and a hybrid control unit (HCU) 2, which are already mounted within a vehicle. The BMS 1 may be configured to monitor the overall state of a high-voltage battery of a vehicle, and provide information regarding battery SOC, battery temperature, and battery voltage for the HCU 2. The HCU 2 (e.g., a controller executing the method of the exemplary embodiment) may be configured to variably adjust a motor output limit such as a motor charge power limit and a motor discharge power limit based on the information regarding battery SOC, battery temperature, and battery voltage received from the BMS 1.

More specifically, the HCU 2 may be configured to determine a primary motor output limit such as the motor charge power limit for limiting the maximum value of motor charge power and the motor discharge power limit for limiting the maximum value of motor discharge power based on the battery SOC and battery temperature information, and may be configured to determine a final motor output limit by determining a weighting factor of the primary motor output limit based on the battery SOC and battery voltage information and correcting the primary motor output limit. In particular, the motor charge power limit may be a motor output limit when the battery is charged, and the motor discharge power limit may be a motor output limit when the battery is discharged. Additionally, the HCU 2 may be a motor output controller configured to variably adjust the motor output. Various controllers (e.g., motor control unit (MCU) and generator control unit (GCU)) mounted within a vehicle and capable of adjusting the motor output may be adopted as the motor output controller substituting for the HCU 2.

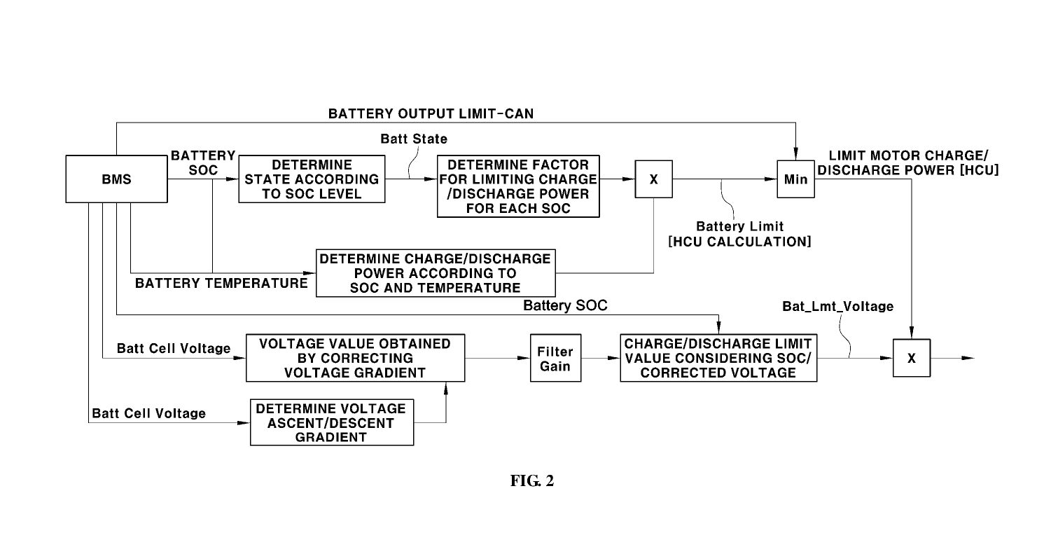

Hereinafter, a method for controlling the battery charge and discharge in an eco-friendly vehicle according to an exemplary embodiment of the present invention will be described with reference to FIG. 2. The HCU 2 may be configured to receive the information regarding battery SOC, battery temperature, and battery voltage detected by the BMS 1, and the battery output limit for limiting the battery maximum output during the battery charge/discharge.

Further, the HCU 2 may be configured to determine the battery SOC state based on the battery SOC level by a first table that is pre-generated based on the battery SOC to determine the weighting factor for limiting the battery maximum output during the battery charge/discharge based on the battery SOC information, and may be configured to determine the weighting factor (e.g., battery maximum output weighting factor) for limiting the battery maximum output by a second table that is pre-generated based on the determined battery SOC state. The battery SOC level may be dividedly set by a certain section, and the battery SOC state may be set by dividing the battery charge (or discharge) state by stages based on the battery SOC level.

The first table may be generated to determine the battery SOC state based on the battery SOC level, and may be stored in the HCU 2. The second table may be generated to determine the battery maximum output weighting factor based on the battery SOC state, and may be stored in the HCU 2. In other words, the first table may be an order table for determining the battery SOC state based on the battery SOC level, and may be built to determine the battery SOC state based on the battery SOC level to which the battery SOC input from the BMS 1 corresponds. The second table may be an order table for determining the battery maximum output weighting factor based on the battery SOC state divided into at least two, and may be generated to determine the battery maximum output weighting factor based on the battery SOC state determined by the first table.

Additionally, the HCU 2 may be configured to determine the battery maximum output by a third table that is pre-generated based on the battery SOC and the battery temperature, to determine the battery maximum output during the battery charge and discharge based on the battery SOC and battery temperature information. The third table may be an order table for determining the battery maximum output based on the battery SOC and battery temperature information, and may be generated to determine the battery maximum output based on the battery SOC and battery temperature information.

The HCU 2 may be configured to calculate a battery output limit by multiplying the battery maximum output determined by the third table by the battery maximum output weighting factor determined by the second table, and then may be configured to compare the battery output limit with the battery output limit input from the BMS 1 to determine a value obtained by subtracting a certain margin from a smaller one of the two battery output limits as a primary motor output limit (e.g., motor output limit before correcting based on battery voltage information).

Furthermore, the HCU 2 may be configured to determine a weighting factor (or battery charge/discharge voltage limit value) of the primary motor output limit based on the battery voltage information input from the BMS 1, and may be configured to determine a final motor output limit as a value obtained by correcting the primary motor output limit using the determined weighting factor. To determine the weighting factor of the primary motor output limit, a battery voltage gradient may be calculated and determined based on the battery voltage information monitored and transmitted by the BMS 1, and a battery voltage value may be corrected based on the battery voltage gradient calculated and determined.

To correct or adjust the battery voltage value, the battery voltage value (e.g., result value obtained by correcting battery voltage) corrected by the battery voltage correction table (or fourth table) that is pre-generated based on the battery voltage gradient may be determined. The battery voltage correction table may be an order table for determining the battery voltage value corrected based on the battery voltage gradient, and may be generated to determine the battery voltage value corrected based on the battery voltage gradient. The battery voltage correction table may be stored in the HCU 2.

In particular, when the battery voltage gradient is ascending, the final motor output limit may be determined as the motor charge power limit. When the battery voltage gradient is descending, the final motor output limit may be determined as the motor discharge power limit. Thus, the weighting factor of the primary motor output limit may be determined based on battery SOC information and the battery voltage value corrected based on the battery voltage gradient. In particular, the battery voltage value determined and corrected by the fourth table may use a value filtered at a ratio of about 0% to 100%.

In addition, to determine the weighting factor of the primary motor output limit, a weighting factor table (or fifth table) for determining and adjusting the weighting factor of the primary motor output limit based on the corrected battery voltage value and battery SOC information may be pre-generated and stored in the HCU 2. The HCU 2 may be configured to correct or adjust the primary motor output limit and determine the final motor output limit by multiplying the primary motor output limit by the weighting factor of the primary motor output limit determined by the weighting factor table.

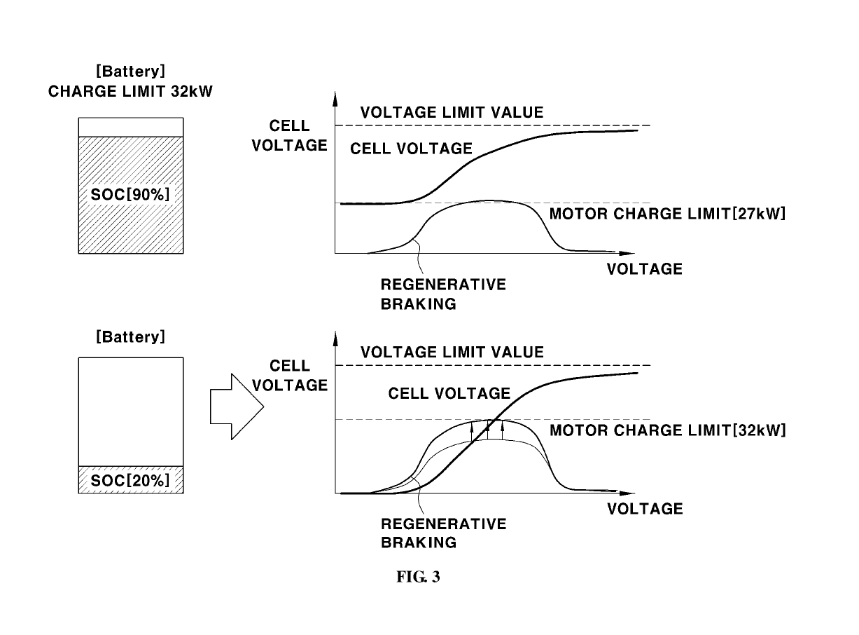

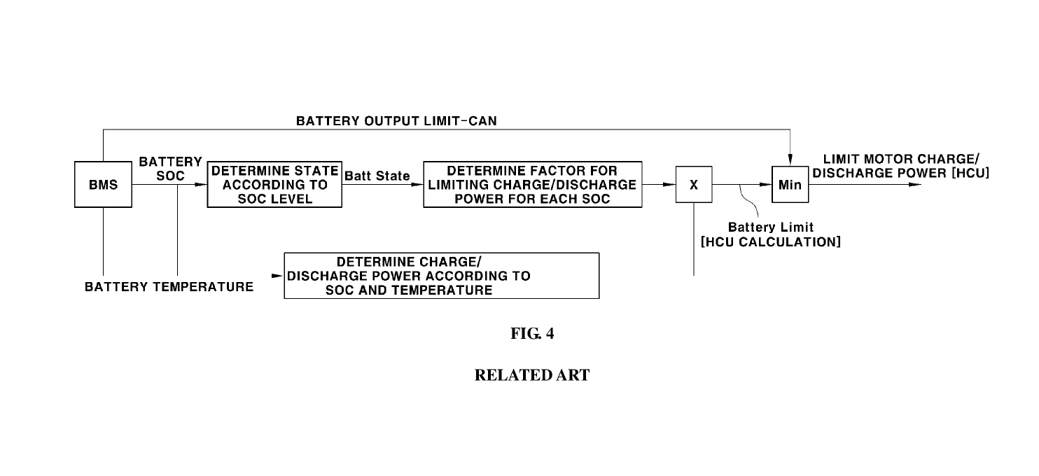

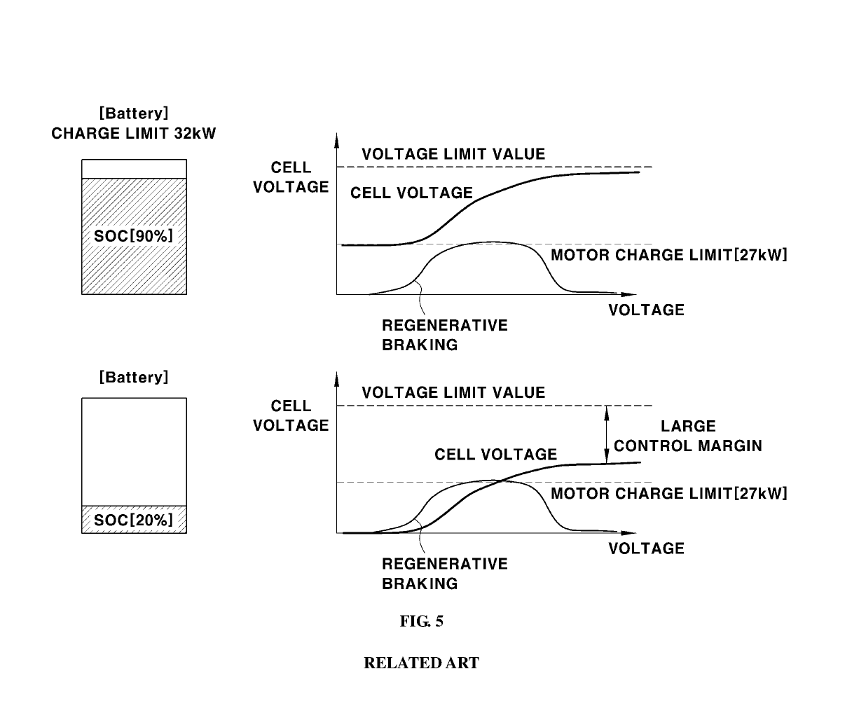

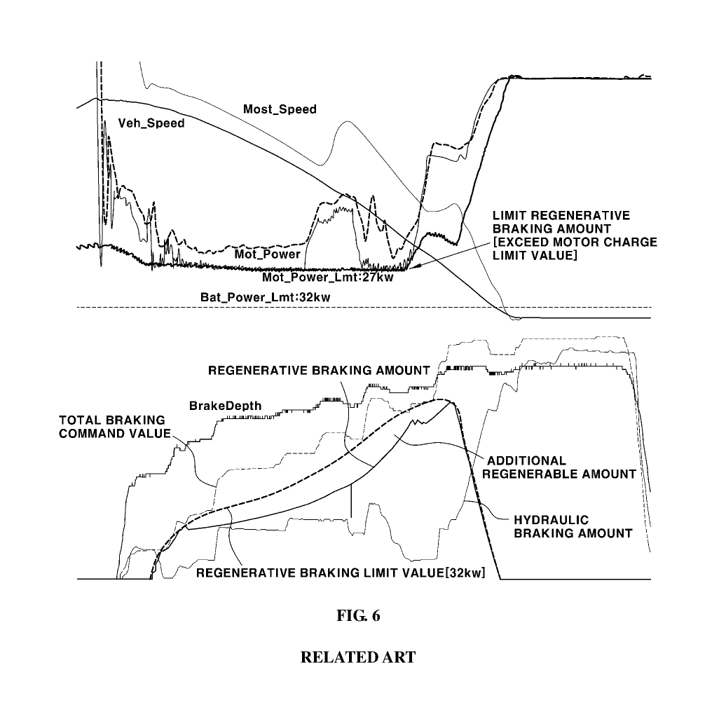

In this exemplary embodiment, the final motor output limit may be variably adjusted using the weighting factor of the primary motor output limit determined based on the battery voltage and the battery SOC. Thus, as shown in FIG. 3, when the control margin between the battery output limit and the battery cell voltage is substantial (e.g., when the battery SOC is low), the final motor output limit for limiting the motor maximum output may increase, thereby increasing the maximum regenerative braking amount, securing additional motor output and improving the fuel efficiency and the power performance.

Particularly, for an eco-friendly vehicle to which a transmission mounted electric device (TMED) system is applied, since the motor capacity is relatively poor compared to the battery capacity due to the installability of the hybrid system in the engine room and the manufacturing cost of a vehicle, there is difficulty in fuel efficiency/drivability control in which the maximum output of the motor is optimized. However, according to the exemplary embodiment of the present invention, since the output of the motor may increase using an existing system for vehicle driving, the increase of the regenerative braking amount and the improvement of acceleration performance may be achieved. Additionally, it may be possible to secure an additional motor output using existing hardware without addition of parts compared to a related art and simultaneously improve the fuel efficiency and the power performance.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A device for controlling a battery charge and discharge quantity in an eco-friendly vehicle, comprising:
a motor output controller configured to:
determine a primary motor output limit based on information regarding battery state of charge (SOC) and battery temperature;
determine a weighting factor of the primary motor output limit based on information on the battery SOC and battery voltage; and
determine a final motor output limit by correcting the primary motor output limit using the weighting factor.

2. The device of claim 1, wherein the motor output controller is configured to:
calculate a battery voltage gradient based on the battery voltage information; and
determine the weighting factor of the primary motor output limit based on the battery SOC, and a battery voltage value corrected based on the calculated battery voltage gradient.

3. The device of claim 1, wherein the motor output controller is configured to:
determine a corrected battery voltage value based on a battery voltage gradient by a battery voltage correction table; and
determine the weighting factor of the primary motor output limit based on the battery SOC and the corrected battery voltage value by a weighting factor table.

4. The device of claim 1, wherein the motor output controller is configured to:
receive the information regarding battery SOC, battery temperature, and battery voltage from a battery management system (BMS).

5. A method for controlling a battery charge and discharge quantity in an eco-friendly vehicle, comprising:
determining, by a controller, a primary motor output limit based on information on battery state of charge (SOC) and battery temperature;
determining, by the controller, a weighting factor of the primary motor output limit based on information regarding battery SOC and battery voltage; and
determining, by the controller, a final motor output limit by correcting the primary motor output limit using the weighting factor.

6. The method of claim 5, wherein the determining of the weighting factor includes:
calculating, by the controller, a battery voltage gradient based on the battery voltage information; and
determining, by the controller, the weighting factor of the primary motor output limit based on the battery SOC and a battery voltage value corrected based on the calculated battery voltage gradient.

7. The method of claim 5, wherein the determining of the weighting factor includes:
determining, by the controller, a corrected battery voltage value based on a battery voltage gradient by a battery voltage correction table; and
determining, by the controller, the weighting factor of the primary motor output limit based on the battery SOC and the corrected battery voltage value by a weighting factor table.

8. A non-transitory computer readable medium containing program instructions executed by a controller for adjusting a battery charge and discharge quantity in an eco-friendly vehicle, the computer readable medium comprising:
program instructions that determine a primary motor output limit based on information on battery state of charge (SOC) and battery temperature;
program instructions that determine a weighting factor of the primary motor output limit based on information regarding battery SOC and battery voltage; and
program instructions that determine a final motor output limit by correcting the primary motor output limit using the weighting factor.

9. The non-transitory computer readable medium of claim 8, further comprising:
program instructions that calculate a battery voltage gradient based on the battery voltage information; and
program instructions that determine, the weighting factor of the primary motor output limit based on the battery SOC and a battery voltage value corrected based on the calculated battery voltage gradient.

10. The non-transitory computer readable medium of claim 8, further comprising:
program instructions that determine a corrected battery voltage value based on a battery voltage gradient by a battery voltage correction table; and
program instructions that determine the weighting factor of the primary motor output limit based on the battery SOC and the corrected battery voltage value by a weighting factor table.
